(19) United States
(12) Patent Application Publication
(10) Pub. No.: US 2022/0057084 A1
(43) Pub. Date: Feb. 24, 2022

(54) Energy And Environmental Optimisation Of A Facility Comprising At Least One Combustion Apparatus With Burner

(71) Applicant: Bulane, Fabregues (FR)

(72) Inventors: Nicolas Jerez, Lattes (FR); Henri Champseix, Montferriez Sur Lez (FR)

(73) Assignee: Bulane, Fabregues (FR)

(21) Appl. No.: 17/312,710

(22) PCT Filed: Dec. 12, 2019
(86) PCT No.: PCT/EP2019/084954

§ 371 Date: Jun. 10, 2021

(30) Foreign Application Priority Data
Dec. 12, 2018 (FR) 1872780

(51) Int. Cl. F23D 14/32; C25B 1/04; C25B 15/02; F23L 7/00; F23N 1/02; F24D 3/00

(52) U.S. Cl. CPC F23D 14/32; C25B 1/04; C25B 15/02; F23L 7/007; F23N 1/022; F24D 3/005; F23N 2241/06; F23L 2900/07005; F23L 2900/07006; F24D 2200/19; F24H 2240/10; F23N 2237/08; F23K 2203/103

(57) ABSTRACT

The invention concerns a system for energy and environmental optimisation of a facility comprising at least one combustion apparatus (1) with a burner (3). The system comprises an electrolyser (2) and an injection system (4) connected to at least one fuel (3a) and/or oxidant (3b) inlet of the burner (3). The injection system is capable of injecting, at such an inlet, gases from the electrolyser (2) and/or a mixture of these gases and a combustible fluid and/or an oxidising fluid. The electrolyser (2) and/or the injection system (2) are controlled on the basis of at least one piece of information originating from the combustion apparatus (1) and/or sensors (6x) of the installation. The electrolyser can comprise a heat exchanger (2a) for cooling the device and/or preheating the water (EP) that is intended to then be heated (EC) by the combustion apparatus (1).

### GENERAL TECHNICAL FIELD AND PRIOR ART

The present invention relates to a system for energy and environmental optimization of a facility comprising at least one combustion apparatus with burner.

It is generally known that it is desirable to be able to improve the energy efficiency and the life span of equipment with burners (boilers, furnaces, etc.), in particular of those of individual or collective dwellings or of companies.

In particular, combustion apparatus have limited efficiency because they use mainly air as oxidant, with only a small part of molecular oxygen and the rest being predominantly nitrogen.

Furthermore, there is a desire to strongly reduce the emissions of greenhouse gases or other pollutants such as for example CO2, CO or nitrogen oxides (NOx), pollutants and toxic generated by this existing equipment which consumes air as oxidant.

There is also a desire to reduce the dependence on and consumption of fossil fuels used to operate this equipment.

The energy consumed in buildings is indeed a major source of CO2 emissions and improving the efficiency of combustion apparatus is a lever identified as likely to have a significant impact on greenhouse gas emissions.

Another important way to fight against polluting emissions is the use of renewable energies, particularly in the form of electricity, such as solar or wind energy.

Their applications, particularly in homes, are currently limited in that the production of electrical energy that they allow is often out of sync with the consumption demand.

One solution that is now beginning to be implemented is “Power-to-Gas”. The electricity mainly derived from these renewable energies is transformed into hydrogen by water electrolysis. Thus converted, these energies can be stored and transported by current networks such as city gas networks.

However, “Power-to-Gas” solutions are still not widely deployed today. In particular, the current urban underground networks, such as city gas, are not always adapted to transport, in particular hydrogen, whether or not combined with city gas, in compressed form.

Moreover, combustion apparatus that are not connected to city gas networks cannot benefit from these “Power-to-Gas” solutions. Instead, these combustion apparatus are connected to electrical networks, and sometimes even to a local electricity production facility.

Furthermore, hydrogen production by electrolysis is accompanied by oxygen production that is not recovered. This represents the loss of a significant part of the gases produced during the electrolysis operation.

Finally, a significant part of the electrical energy used in electrolysis is lost in the form of waste heat generation (Joule effect) and not recovered, which limits the overall efficiency of this operation.

Thus, there is a general need for a solution allowing the local use of hydrogen and/or oxygen generation and storage, without transport in city gas networks, with recovery of oxygen and of the heat produced during electrolysis. This solution allows the energy and environmental optimization of a facility comprising a combustion apparatus with burner.

### General Presentation of the Invention

A general aim of the invention is to overcome the drawbacks of the prior art.

To this end, the invention proposes to hybridize all types of combustion apparatus, whether or not connected to the city gas network, comprising at least one burner, including in particular the combustion apparatus of individual or collective dwellings, or of companies, with local electrolyzers located close to these combustion apparatus. The invention advantageously allows the use of a renewable or non-renewable source of electricity to generate decarbonized heat in combustion apparatus initially using carbon-based fossil fuels.

These local electrolyzers are connected to the fuel and/or oxidant inlets of these combustion apparatus.

They allow the injection of locally generated hydrogen and/or oxygen—in individual or mixed form—in order to neutralize all or part of the generation of polluting and toxic gases such as NOx, CO2 or CO.

Thanks to this injection of hydrogen and/or oxygen, the combustion carried out and the efficiency of the combustion apparatus are clearly improved, in particular because of the calorific and energetic contribution of these gases supplied by the electrolyzer. Moreover, the combustion is cleaner, with less fouling (generation of particles, etc.) which also makes the combustion apparatus more durable and limits their maintenance.

Furthermore, these electrolyzers reduce the cost of the initial fossil fuel, which continues to increase due to the tension of the world markets on energy resources.

The distribution of the hydrogen and/or oxygen injection into the combustion apparatus is controlled by an electronic module located at the facility, which can be connected to the combustion apparatus, to the hydrogen and/or oxygen production device as well as to sensors.

The latter can further comprise a communications unit that exchanges with a remote server to transmit various operating parameters of the facility on a regular basis or on demand.

This server therefore capitalizes on the operating behavior of a multitude of facilities comprising combustion apparatus.

This remote server can in addition exchange with local control modules in order to send them information that modifies their gas injection distribution programming.

In addition, and advantageously, in order to improve the efficiency of the facility, the heat energy released by the electrolyzer during hydrogen and/or oxygen generation is itself used to preheat the water circulating in the combustion apparatus (recovery of the heat lost through cogeneration) by means of a heat exchanger.

This heat energy can also be used to supply secondary circuits (water heaters for domestic hot water, for example).

The surplus molecular hydrogen can itself be stored locally in order to be used later, in a desynchronized fashion, to feed the combustion apparatus of the facility, or converted into electrical energy on site by means of a fuel cell.

The electrolyzer can also be powered by a renewable energy source such as solar (photovoltaic panels), wind, hydro, or any “green” electricity generator.

In particular, this renewable energy source can be used to generate hydrogen and/or oxygen, when the combustion apparatus is not in operation. The hydrogen and/or oxygen thus produced is then stored.

In general, such a local system allows for a very high overall efficiency, due to the production of hydrogen, the production and recovery of oxygen, and due to the recovery of the thermal energy generated during the electrolysis reaction.

In addition, gas transport and energy losses due to the Joule effect are avoided.

Thus, according to one aspect, the invention proposes a system for energy and environmental optimization of a facility comprising at least one combustion apparatus comprising a burner, characterized in that it comprises:
at least one device for producing hydrogen and/or oxygen by water electrolysis,
at least one injection system connected to at least one fuel and/or oxidant inlet of the combustion apparatus, said system being able to inject at such an inlet gases coming from said device for producing hydrogen and/or oxygen by water electrolysis, and/or a mixture of these gases as well as a fuel fluid and/or an oxidant fluid,
a local electronic module connected to the device for producing hydrogen and/or oxygen by water electrolysis, to the combustion apparatus and/or to sensors equipping the facility, said module controlling the production device and/or the injection system as a function of at least one piece of information coming from the combustion apparatus and/or the sensors of the facility.

According to yet another aspect, a system is proposed in which the device for producing hydrogen and/or oxygen by water electrolysis comprises a heat exchanger for cooling said device and/or for preheating the water which is intended to be subsequently heated by the combustion apparatus.

Advantageously, the injection system comprises fluidic components for controlling, according to different modes, the injection of hydrogen and/or oxygen gases on the fuel inlet of the burner of the combustion apparatus and/or on the oxidant inlet of the burner of the combustion apparatus.

In particular, the electronic module is adapted to control the different injection modes in order to allow the injection of all or part of the hydrogen and/or oxygen gases on the fuel inlet of the burner of the combustion apparatus and/or all or part of the hydrogen and/or oxygen gases on the oxidant inlet of the burner of the combustion apparatus.

According to an alternative embodiment, furthermore, the injection system is adapted so that the mixing of hydrogen and/or oxygen gases with a fuel fluid or an oxidant fluid is carried out inside said system, before injection on at least one fuel and/or oxidant inlet of the combustion apparatus.

Also, the electronic module can comprise at least one telecommunication module allowing the transmission to a remote server of the data of the combustion apparatus and/or of the hydrogen and/or oxygen production device and/or of the sensors of the facility.

In addition, the system may comprise a remote server that stores and processes operating data received from one or more electronic module(s) to generate, for example, maintenance information.

In a possible alternative embodiment, the device for producing hydrogen and/or oxygen by water electrolysis is coupled to a renewable energy power source.

Alternatively or additionally, the system also comprises a local storage system capable of storing all or part of the surplus hydrogen and/or oxygen generated by the water electrolysis production device, the electronic module being capable of controlling the injection system in order to subsequently supply, in a manner that is desynchronized with the production of hydrogen and/or oxygen, the combustion apparatus with the hydrogen and/or oxygen thus stored.

The system may further comprise a fuel cell receiving as input hydrogen stored in said storage system and converting the hydrogen into electrical energy.

### PRESENTATION OF FIGURES AND DESCRIPTION

The following description is purely illustrative and non-limiting. It should be read in conjunction with the appended drawings in which:

FIG. 1 illustrates a boiler circuit incorporating an electrolyzer in accordance with a possible embodiment of the invention, and more generally an assembly (denoted 10) comprising at least one combustion apparatus with burner(s) and at least one energy and environmental optimization system;

FIG. 2 illustrates schematically the burner of such a boiler and its different intake modes;

FIG. 3 illustrates a facility comprising at least one energy and environmental optimization system in which the electrolyzer and/or the injection system are integrated into the combustion apparatus.

### DESCRIPTION OF ONE OR MORE EMBODIMENTS

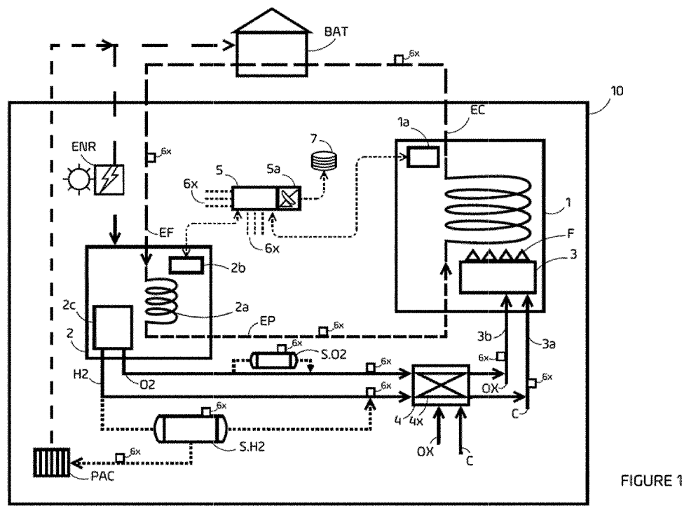

The facility shown in FIG. 1 comprises a combustion apparatus 1 and an electrolyzer 2.

The apparatus 1 has a burner 3 and can be of any type: boiler, ovens, etc. The facility of which it forms part can equip a building BAT, such as a single-family dwelling. Alternatively, the facility can be provided for a collective dwelling or for a company building.

In the example of FIG. 1, the combustion apparatus 1 is an individual boiler using liquid or gaseous fossil fuel C: domestic fuel oil, propane, butane, city gas, etc., and whose oxidant OX is air. It ensures the central heating of a dwelling BAT, the heating of a main hot water circuit or that of a secondary circuit.

Its burner 3 heats a heat-transfer fluid or a hot-water circuit EC-EF-EP.

The electrolyzer 2 can use several types of electrolysis technologies such as alkaline or proton-exchange membrane (PEM).

It can advantageously be integrated into the combustion apparatus 1, in order to simplify the electronic and/or mechanical interfacing between said apparatus 1 and said electrolyzer 2. Alternatively, it can be outside the combustion apparatus 1, but on the same site as the latter, as close as possible to said apparatus 1 with a view to its hybridization with the latter.

Its power is dimensioned in relation to the combustion apparatus 1, whose efficiency and combustion it must optimize. For example, for an individual domestic use, the power of the electrolyzer can be situated between 200 and 3000 W.

In order to generate hydrogen H2 and oxygen O2, it is fed, continuously or not, with water from the network, rainwater, or filtered and/or purified water (demineralized, osmosed, distilled, etc.).

In order to optimize the energy efficiency of the facility and in particular of the electrolyzer 2, the cold water EF from the return of the heating circuit can be admitted in the exchanger 2a allowing, on the one hand, the heat generated during the electrolysis operation to be recovered and, on the other, the electrolyzer 2 to be cooled for optimal functioning.

This water can be preheated EP by means of the heat exchanger 2a, which can be located inside or at the outlet of the electrolyzer 2, by the thermal reaction produced therein. It may or may not be integrated with the electrolysis cell 2c.

This exchanger 2a is for example a liquid/liquid or air/liquid heat exchanger.

The preheated water EP coming from the exchanger 2a of the electrolyzer 2 is then sent to the boiler 1 to be heated (hot-water circuit EC). It can also be used to supply secondary circuits (water heater for domestic hot water, for example).

It is advantageous to incorporate the electrolyzer 2 directly inside the boiler because this allows for a mechanically simpler system with simpler fluid transfers. This makes it possible to design a boiler with an integrated electrolyzer right from the design/manufacturing stage, and thus to bring the components/functions as close as possible from a fluidic, mechanical, thermal, electronic and computer point of view. This also enables gains in terms of compactness, weight, safety and manufacturing costs.

The heat exchanger 2a can advantageously be integrated into the electrolyzer 2, or even directly into the electrolysis cell 2c. In order to allow the most optimal heat transfer possible, it is advantageous to capture the heat released as close as possible mechanically, fluidically and thermally to the cell 2c. This avoids heat losses and/or fluidic constraints that would be induced by an exchanger that would be deported outside the electrolyzer 2 and for which the calories would have to transit via a heat-transfer fluid. A pump would also be necessary for the circulation, inducing an additional energy consumption. By integrating the heat exchanger 2a in the electrolyzer 2 or directly on the electrolysis cell 2c, the overall efficiency is improved (thermal, energetic, mechanical, fluidic, etc.). This technical configuration becomes a definite additional advantage in the case where it is desired to integrate the electrolyzer 2 inside the boiler.

The hydrogen H2 and/or oxygen O2 gases are sent via the multichannel injection system 4 to the burner inlets 3 of the boiler 1 in order to improve the combustion of the latter.

The hybridization regime, i.e., the intake ratio between the hydrogen H2 and/or oxygen O2 gas, and the initial fossil fuel C and/or oxidant OX, can advantageously range from 0% to 100%.

Typically, in city gas, the mixture in the combustion apparatus 1 can be enriched with hydrogen H2 (of the order of 6 to 20% by mass).

Hybridization provides a decarbonized energy contribution to the fossil combustion thus achieved. In particular, it improves the carbon and environmental balance (the flames F of the burner 3 of the combustion apparatus 1 generate less NOx, CO2, CO, etc.) and improves energy efficiency.

In particular, oxygen O2 prevents the formation of NOx, while hydrogen H2 optimizes the combustion of fossil fuels C.

It should also be noted that the proposed system allows the oxygen O2 produced by the electrolyzer 2 to be recycled instead of being released into the atmosphere because it cannot be stored and/or transported simultaneously with the hydrogen in the city gas networks.

This increases the overall yield.

In combination with the cogeneration carried out by the exchanger 2a, the recovery of oxygen O2 increases the overall efficiency of the electrolysis and combustion process, the overall thermal efficiency of the electrolyzer 2 can reach up to 98%.

Gas production is also carried out on-site, which avoids the problems of transporting and adapting gas networks.

The system also comprises an electronic module 5 connected to the electrolyzer 2, to the combustion apparatus 1 and/or to sensors 6x of the facility, which are shown non-exhaustively in FIG. 1 because their number and types depend on the combustion apparatus 1 to be hybridized.

The sensors 6x are typically thermal probes, gas flow meters, pressure sensors or gas/liquid flow meters. They are located, for example, on circuits in which water or heat-transfer fluid circulates EC-EF-EP. Or they can be located on circuits where fuels C and/or oxidants OX circulate. These sensors 6x may also be internal to the combustion apparatus 1 and/or the electrolyzer 2.

The module 5 controls the electrolyzer 2 and/or the intake of hydrogen H2 and/or oxygen O2 gases into the combustion apparatus 1. This electronic module 5 may or may not be integrated into the electrolyzer 2, in association or not with its control electronics 2b.

The control it performs is a function of information transmitted by the electronics 1a of the combustion apparatus 1 and/or by the sensors 6x of the facility.

For example, the module 5 starts up the electrolyzer 2 when the starting up of the combustion apparatus 1 is detected.

It also controls the intake of hydrogen H2 and/or oxygen O2 gas at the intake inlets 3a and 3b of the combustion apparatus 1 as long as the water circulating in the circuit EC-EF-EP has not reached a given temperature set point.

The detection of the start-up of the electrolyzer 2 is done for example by detection of the call of the fuel C in the system, typically:
detection by the consumption of fossil fuel C by means of a gas flow meter 6x;
detection by the consumption of fossil fuel C by means of a pressure sensor 6x (typically, for example, a consumption is detected when a depression or a pressure lower than the reference pressure is detected);
detection of the electrical switching of the intake valve for fossil fuel C;
detection by an electronic command established by the electronic module 5 dialoguing between the electrolyzer 2 and the combustion apparatus 1.

More generally, the module 5 controls the intake of C, OX, H2 and/or O2 fluids into the boiler 1 via the injection system 4 in order to control the state of combustion in coherence with the consumption of fuel C/oxidant OX.

It is programmed according to the type of combustion apparatus 1 and the fuel C used in order to obtain the maximum energy efficiency with the aim of consuming as little fossil fuel C as possible.

The system further comprises an injection system 4 for the H2 and/or O2 gases coming from the electrolyzer 2. This injection system 4 (typically consisting of mechanical parts and fluidic components 4x such as mixers, flaps, control valves—manual and/or electronically controlled—solenoid valves, circulation and/or routing tubes, restrictions, etc.) is connected to at least one fuel inlet 3a and/or at least one oxidant inlet 3b of the combustion apparatus 1.

Thus, the combustion apparatus 1 can integrate the injection system 4 defining several fluid injection paths in particular for mixing the hydrogen H2 gas and/or oxygen O2 gas either in the fuel C or in the oxidant OX. The injection system 4 is connected to the burner 3 by means of the injection connections 8a and 8b.

For example, these gases can be injected into the burner 3 of the combustion apparatus 1, separately or simultaneously, via the air intake (oxidant OX).

They can also be injected into the burner 3 of the combustion apparatus 1, separately or simultaneously, via the city gas inlet (fuel C).

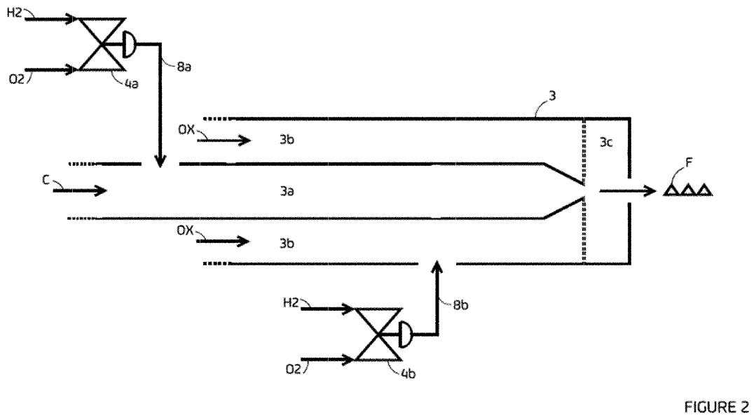

In another alternative, the mixing between the hydrogen gases, the oxygen gases and the fuel (or oxidant) fluid can be carried out inside the injection system 4 which is configured for this purpose. The injection on the inlets/outlets 3a and 3b then takes place after mixing. In the example on FIG. 2, two inlets 3a and 3b allow the injection of hydrogen H2 and/or oxygen O2 gases, respectively:
inlet 3a: with methane C (injection pipe 8a) into the chamber of the burner 3;
inlet 3b: with air OX (injection 8b), directly at the flame F of the burner 3.

Mixers 4a and 4b are provided upstream of these two inlets 3a and 3b to control the proportions of hydrogen H2 and oxygen O2 sent to each.

This possibility of injection on the various inlets of the combustion apparatus 1 covers all the possible modes of intake of the fluids C, OX, H2, O2 in order to optimize the combustion.

For a given lower calorific value (LCV), different volumes of fuel are required. If hydrogen is compared with methane or LPG (like propane or butane for example), there is a factor of about 3. That is to say that, by volume, about 3 times more hydrogen is needed to obtain an identical LCV. This means that when hydrogen (and/or oxygen) is injected into the initial fuel, a part of its initial volume is replaced and therefore a part of the initial LCV is removed. To compensate for this effect and thus improve the energy efficiency, performance/yields or energy optimization of the facility, it is advantageous to inject hydrogen and/or oxygen, also on the oxidant inlet side of the burner. In addition to avoiding a limitation of the fuel volume/LCV, this intake possibility (3b) also covers a wider range of possible parameterizations, thanks to a dual regulation (energy input on the fuel side and/or on the oxidant side) and a finer control of the final combustion of 100% of the inputs, namely: hydrogen, oxygen, oxidant (generally ambient air) and initial fuel.

To this end, the controlled intake modes can be on/off or proportional (0 to 100% hydrogen H2 and/or oxygen O2, fuel C side and/or oxidant OX side), which allows the fluids to be injected, individually or collectively, mixed or not, completely or partially, through at least one of the inlets 3a and/or 3b of the burner 3 of the combustion apparatus 1. This allows a complete control.

The electronic module 5 can regulate the injection system 4 according to different operating phases of the combustion apparatus 1 and define the gas/liquid flows to be injected on the different inlets 3a and/or 3b so as to admit the “best fuel/oxidant ratio” in the burner 3 of the combustion apparatus 1.

In particular, it performs the following functions:
Establishment of the request by the electronic 1a which ensures the feedback control of the boiler 1;
Control of the electrolyzer 2 to give the initial hydrogen H2 and/or oxygen O2 flow rates;
Adjustment of openings/flow rates on intake fluidic components 4x.

It should also be noted that the adjustment of the injection system 4 can be carried out either electronically or manually in order to allow for correct adaptation to each model of combustion apparatus 1 and in particular to their operating speeds and/or burner 3 models.

Also, the electronic module 5 comprises at least one telecommunication module 5a allowing it to exchange data with a remote server 7. The communication can be by any means: GSM mobile telephony, low-consumption communications such as RFID, SigFox, LoRa or LTE-M, PLC currents to a centralization node between several dwellings, etc.

The data transferred to the server 7 are, for example, operating data from the combustion apparatus 1, the electrolyzer 2, as well as data from the sensors 6x of the system or from the settings of the fluidic components 4x of the injection system 4.

The server 7 can thus perform the following functions, among others:

monitoring, maintenance, storage and analysis of data from different types of combustion apparatus 1.

The energy optimization of a fossil combustion is allowed by the injection of hydrogen and/or oxygen (on the fuel or oxidant side); these gases being produced by a water electrolysis system (with heat recovery if possible via an exchanger or inside the system), and said gases being mixed by a multichannel system for dosing the composition (in particular the volume ratio of hydrogen, oxygen, oxidant (generally ambient air) and the initial fuel). This modification of the initial fuel and of the oxidant at the burner inlet has the effect of substituting a part of the initial fossil fuel by an electricity consumption (electrons). In order for this energy substitution to be environmentally relevant, it seems obvious to connect such a facility to renewable electrical energy sources offering electrical energy produced with low CO2 emissions.

But this is not sufficient, because if the system is permanently connected to renewable energy sources it will then have a reduced operating range. In particular because renewable energy sources do not work well at night, are intermittent, or when there is no wind or sun. Moreover, if the facility is permanently connected to the traditional electrical network, then it will not know when it is relevant to operate by ensuring that it will consume electrical energy with less environmental impact than the initial fossil fuel it will substitute.

An interaction with the electrical distribution network is therefore advantageous to allow the energy optimization system to deliver its high-added-value environmental function. This interaction can be realized by means of a remote telecommunication system interfaced between the facility and the electrical smart grid to which it is connected (electrically). This remote telecommunication allows the facility to be adaptable and thus allows it to deliver a hot water production with a low CO2 emission. Moreover, the facility can be connected, monitored, and/or controlled by the operators and/or the energy regulators (servers). On the one hand, this will make it possible to correctly choose/trace the source of electricity used through different mechanisms (blockchain, energy certificates, etc.), and on the other hand, to switch in real time from one source of electrical energy to another according to parameters determined by the electrical network (controlled signal, off-peak/peak hours, blue/green hours, etc.). It is also possible to switch to the local power generation plant for self-consumption. In such an embodiment where a self-generation power plant would exist in the vicinity of the facility, the telecommunication system and the remote server can determine that it is better to switch to this local power source, and control this switching. It will thus be possible to guarantee that the facility will be supplied with the most environmentally and/or economically competitive electrons (in this case, produced locally and off-grid).

Furthermore, the remote telecommunication system advantageously makes it possible to send to the server different parameters related to security, monitoring, energy consumption, the amount of energy consumed by type of electricity source, savings in terms of CO2 emissions achieved and calculated in real time. It is also possible to send different parameters related to predictive and curative maintenance, billing of energy services, environmental certifications etc.

Thus, the distribution network is advantageously able to control the start-up and stopping of the hydrogen and/or oxygen production device 2 and the remote server 7 is able to transmit parameters representative of the ratio of hydrogen, oxygen and fuel fluid to be injected on the fuel inlet 3a and also of the ratio of hydrogen, oxygen and oxidant fluid to be injected on the oxidant inlet 3b.

It is known that the cheapest energy with the lowest CO2 emission is the one produced by renewable electrical energy sources, which is transported the least distance and consumed the fastest. The facility adds value in situations in which the energy whose production required a low CO2 emission is used in reinforcement or substitution of a fossil combustion. To this end, it is advantageous that the facility can obtain information about the electrical sources to be chosen, in order to be able to optimize the targeted fossil combustion energetically and environmentally. The facility thus allows a depollution/reduction of the CO2 released by the initial fuel via a direct electric consumption which is more competitive (environmentally and economically) than the storage of this electric energy. Moreover, the energy sources with low CO2 emissions are becoming cheaper than other production systems every year, so such a hybridization of fossil fuel combustion with electrical energy from energy sources with low CO2 emissions will be more competitive in the future. And the same applies to electrical energy that would be produced locally, off-grid, in self-production.

As can be seen, the proposed system is easily compatible with existing facilities incorporating one or more combustion apparatus 1 with burners 3.

It makes it possible optimize the energy efficiency of the hydrogen vector without the need to modify or develop new gas transport infrastructures.

The boiler's computer has information on the combustion parameters. In order to respond as quickly and as accurately as possible to changes in the parameters of this combustion, the facility can advantageously communicate/dialog with the boiler in order to calculate, in real time, the best mixtures (hydrogen, oxygen, oxidant and initial fuel) to be carried out, as well as the injection ratios and the injection paths (oxidant and/or fuel). Furthermore, a direct dialogue between the facility and the boiler avoids the use of certain expensive sensors with variable response times (flow meters for example). This direct computer interaction also ensures greater safety.

In the example shown in FIG. 1, the electrolyzer 2 is coupled to a renewable energy power source ENR, in this case photovoltaic panels that are also used to power the electrical grid of the building BAT of the facility.

In FIG. 1, the system also includes a local storage system S.H2 capable of storing all or part of the surplus hydrogen H2 generated by the electrolyzer 2. The system can also include a local storage system S.O2 capable of storing all or part of the surplus oxygen O2 generated by the electrolyzer 2. Local is understood to mean storage in the building or in its immediate vicinity.

The electronic module 5 controls the injection system 4 in order, if need be, to subsequently supply the burner 3 with the stored hydrogen and/or oxygen, in a way that is not synchronized with the production of hydrogen and/or oxygen H2.

The surplus hydrogen H2 and/or oxygen O2 thus stored can also be used to generate electrical energy (typically in FIG. 1, a fuel cell PAC receiving hydrogen H2 stored in said system S.H2 as input and converting the hydrogen into electrical energy to supply the network of the building BAT).

### SUMMARY OF THE ABOVE-DESCRIBED EMBODIMENTS AND FIGURES

The table below summarizes the components implemented in the embodiments of the energy and environmental optimization system of a facility comprising at least one combustion apparatus, presented with reference to FIGS. 1, 2, and 3:

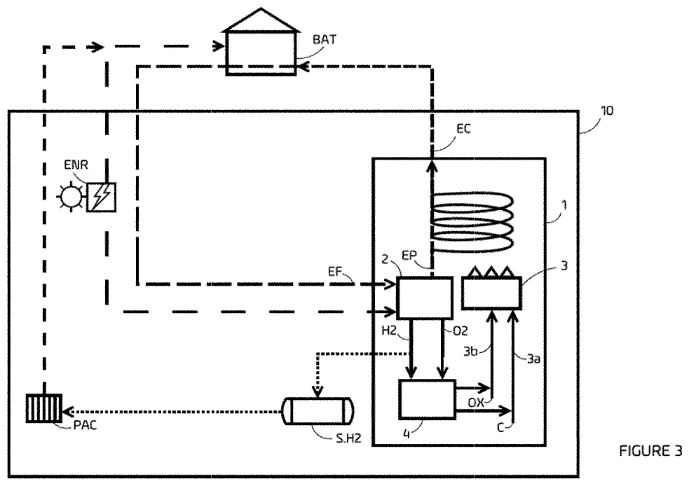

TABLE 1

| Mark | Element/Component | FIG. 1 | FIG. 2 | FIG. 3 |
|---|---|---|---|---|
| 1 | Combustion apparatus | x | | x |
| 1a | Electronic control of the combustion apparatus | x | | |
| 2 | Electrolyzer | x | | x |
| 2a | Heat exchanger of the electrolyzer | x | | |
| 2b | Electronic control of the electrolyzer | x | | |
| 2c | Electrolysis cell | x | | |
| 3 | Burner | x | x | x |
| 3a | Fuel inlet | x | x | x |
| 3b | Oxidant inlet | x | x | x |
| 3c | Burner chamber | | x | |
| 4 | Multichannel injection system | x | | x |
| 4a | Mixers on fuel inlet | | x | |
| 4b | Mixers on oxidant inlet | | x | |
| 4x | Mechanical parts and fluidic components such as | x | | |
| | mixers, flaps, control valves, solenoid valves, | | | |
| | circulation and/or routing tubes, restrictions, etc. | | | |
| 5 | Electronic module | x | | |
| 5a | Electronic communication module | x | | |
| 6x | Sensors of the devices and/or the facility: thermal | x | | |
| | probes, gas flow meters, pressure sensors, gas/ | | | |
| | liquid flow meters, etc. | | | |
| 7 | Remote server & database | x | | |
| 8a | Injection connections on the fuel inlet | | x | |
| 8b | Injection connections on the oxidant inlet | | x | |
| BAT | Building | x | | x |
| C | Fuel inlet | x | x | x |
| EC | Hot water in the heat-transfer circuit | x | | x |
| EF | Cold water in the heat-transfer circuit | x | | x |
| EP | Preheated water in the heat-transfer circuit | x | | x |
| ENR | Renewable energy power source | x | | x |
| F | Flame | x | x | |
| PAC | Fuel Cells | x | | |
| OX | Oxidant/fuel inlet | x | x | x |
| S.H2 | H2 storage | x | | x |
| S.O2 | O2 storage | x | | x |

In a further particularly advantageous application, a facility with at least one energy and environmental optimization system is shown in FIG. 3, in which the electrolyzer 2 and/or the injection system 4 are directly integrated into the combustion apparatus 3.

1. A system for energy and environmental optimization of a facility, the facility comprising at least one combustion apparatus comprising at least one burner, the system comprising:
at least one production device for producing hydrogen and/or oxygen by water electrolysis, and
at least one injection system connected to at least one fuel and/or oxidant inlet of the burner,
the system configured for:
injecting into the fuel inlet gases coming from the production device, and/or a mixture of these gases, as well as a fuel fluid, and/or
injecting into the oxidant inlet gases coming from the production device, and/or a mixture of these gases, as well as an oxidant fluid,
the system comprising at least one electronic module connected to the production device, to the combustion apparatus and/or to sensors equipping the facility,
the module configured for controlling the production device and/or the injection system as a function of at least one piece of information coming from the combustion apparatus and/or the sensors.

2. The system as claimed in claim 1, wherein the production device comprises a heat exchanger configured for cooling the production device and/or for preheating water which is intended to be subsequently heated by the combustion apparatus.

3. The system as claimed in claim 1, wherein the injection system comprises fluidic components configured for controlling according to different modes, an injection of hydrogen and/or oxygen gases on the fuel inlet of the burner and/or on the oxidant inlet of the burner.

4. The system as claimed in claim 3, wherein the electronic module is configured to control the different injection modes to inject all or part of the hydrogen and/or oxygen gases on the fuel inlet of the burner and/or all or part of the hydrogen and/or oxygen gases on the oxidant inlet of the burner.

5. The system as claimed in claim 1, wherein the injection system is configured so that a mixing of hydrogen and/or oxygen gases with a fuel fluid or an oxidant fluid is carried out inside the system before injection on at least one fuel and/or oxidant inlet of the combustion apparatus.

6. The system as claimed in claim 1, wherein the electronic module comprises at least one telecommunication module configured for a transmission to a remote server of data of the combustion apparatus, production device, the sensors and/or the injection system.

7. The system as claimed in claim 6, comprising the remote server that-configured for storing and processing operating data received from one or more electronic module(s) to generate maintenance information.

8. The system as claimed in claim 6,
wherein the remote server is configured to control a start-up of the production device, and/or
the remote server is configured to transmit parameters,
the parameters being representative of:
ratios of hydrogen, oxygen and/or fuel fluid to be injected on the fuel inlet, and/or
ratios of hydrogen, oxygen and/or oxidant fluid to be injected on the oxidant inlet.

9. The system as claimed in claim 1, wherein the production device is coupled to a renewable energy (ENR) power source.

10. The system as claimed in claim 1, comprising a local storage system (S.H2) and/or a local storage system (S.O2) capable of storing all or part of a surplus hydrogen and/or oxygen generated by the production device,
the electronic module configured for controlling the injection system in order to subsequently supply in a manner that is desynchronized with the production of hydrogen and/or oxygen the combustion apparatus with the hydrogen and/or oxygen thus stored.

11. The system as claimed in claim 10, comprising a fuel cell (PAC) configured for receiving as input hydrogen stored in the storage system (S.H2) and converting the hydrogen into electrical energy.

12. An assembly,
the assembly comprising:
at least one combustion apparatus with at least one burner, and
at least one system for energy and environmental optimization of the assembly,
the system comprising:
at least one production device for producing hydrogen and/or oxygen by water electrolysis, and
at least one injection system connected to at least one fuel and/or oxidant inlet of the burner, the system configured for:
injecting into the fuel inlet gases coming from the production device, and/or a mixture of these gases, as well as a fuel fluid, and/or
injecting into the oxidant inlet gases coming from the production device, and/or a mixture of these gases, as well as an oxidant fluid,
the system comprising at least one electronic module connected to the production device, to the combustion apparatus and/or to sensors equipping the facility,
the module configured for controlling the production device and/or the injection system as a function of at least one piece of information coming from the combustion apparatus and/or the sensors.

13. The assembly as claimed in claim 12, wherein the production device and/or the injection system are integrated into the combustion apparatus.

14. The assembly as claimed in claim 12 wherein the combustion apparatus and the injection system are configured to exchange parameters representative of ratios of hydrogen, oxygen and/or fuel fluid to be injected on a fuel inlet and/or ratios of hydrogen, oxygen and/or oxidant fluid to be injected on the oxidant inlet.

15. The assembly as claimed in claim 12 wherein the combustion apparatus is-comprises a boiler.

16. A method for energy and environmental optimization of a facility,
the method comprising:
producing hydrogen and/or oxygen by water electrolysis,
injecting into a fuel inlet of a burner of a combustion apparatus gases coming from the producing step and/or a mixture of these gases, as well as a fuel fluid, and/or
injecting into an oxidant inlet of the burner gases coming from the producing step and/or a mixture of these gases, as well as an oxidant fluid, and
controlling by an electronic module the producing step and/or the injection steps as a function of at least one piece of information coming from the combustion apparatus and/or the sensors of the facility.
